(19) United States
(12) Patent Application Publication
(10) Pub. No.: US 2026/0308018 A1
(43) Pub. Date: Oct. 8, 2026

(54) WATER PURIFIER THAT USES WASTE HEAT FROM THERMOELECTRIC ELEMENT

(71) Applicant: COWAY CO., LTD., Gongju-si (KR)

(72) Inventors: Byung Hyo YE, Gongju-si (KR); Seong Min PARK, Gongju-si (KR); Jong Hwan LEE, Gongju-si (KR); Hyun Goo KIM, Gongju-si (KR); Hee Do JUNG, Gongju-si (KR)

(73) Assignee: COWAY CO., LTD., Gongju-si (KR)

(21) Appl. No.: 19/139,106

(22) PCT Filed: Aug. 31, 2023
(86) PCT No.: PCT/KR2023/013022

§ 371 Date: Jun. 17, 2026

(30) Foreign Application Priority Data
Dec. 20, 2022 (KR) 10-2022-0179347

(51) Int. Cl. C02F 1/16

(52) U.S. Cl. CPC C02F 1/16; C02F 2209/003; C02F 2209/02; C02F 2301/046

(57) ABSTRACT

ABSTRACT: Disclosed is a water purifier that uses waste heat from a thermoelectric element. A water purifier that uses waste heat from a thermoelectric element according to an aspect of the present invention may comprise: a thermoelectric element forming a cooling surface and a heat dissipation surface; a cold water module that contacts the cooling surface and cools purified water; a heat dissipation module that contacts the heat dissipation surface and cools the heat dissipation surface; a preheating module that contacts the heat dissipation module and heats stored purified water; an instantaneous hot water module that heats purified water preheated by the preheating module; a circulation pump; and a controller that controls the circulation pump, the instantaneous hot water module, the thermoelectric element, and the heat dissipation module.

### TECHNICAL FIELD

The present invention relates to a water purifier that uses waste heat from a thermoelectric element, and more particularly, to a water purifier that uses waste heat from a thermoelectric element and improves cooling or heating efficiency by using energy more efficiently.

### BACKGROUND

As environmental pollution increases and interest in health grows, the use of water purifiers is increasing. Such water purifiers include direct connection types that are directly connected to a faucet and storage types in which water is placed in a container and passed through a filter, depending on the type of raw water supply, and include natural filtration types, direct filtration types, ion exchange resin types, distillation types, and reverse osmosis types, depending on the purification method.

Meanwhile, the water purifier includes components such as a filter that filters raw water, a purified water tank that stores purified water filtered by the filter, and a flow path that guides the raw water to the filter, guides the purified water filtered by the filter to the purified water tank, and guides the purified water in the purified water tank to a discharge port when the purified water is extracted according to a user's request.

In addition, recently, with the increase in user demand for fresher water and the trend toward product miniaturization, the use of direct water purifiers without storage tanks has also been increasing, and the use of direct water purifiers that not only provide purified water but also cool or heat the filtered purified water to provide cold water and hot water has also been increasing.

Such direct water purifiers employ an instantaneous hot water heater for instantaneously heating purified water, and the instantaneous hot water heater can generate hot water corresponding to a target temperature in a short time because the flow rate of the purified water accommodated therein is small.

In addition, a cooling module is provided in the direct water purifier to supply cold water. However, conventional water purifiers waste energy by dissipating the heat generated during the cooling of purified water as it is, and rely solely on the instantaneous hot water heater for heating hot water, resulting in a longer time for the hot water to reach the desired temperature, thereby increasing the waiting time for a user to extract hot water. Furthermore, since the flow rate of the supplied hot water is limited, complaints have arisen as the conventional water purifiers fail to meet user demands when a large amount of hot water is required.

Korean Laid-Open Patent Publication No. 10-2015-0094360A relates to an invention concerning a water treatment apparatus equipped with a cold water generation unit and a hot water generation unit, in which purified water filtered through a filter is heated through the hot water generation unit and cooled through the cold water generation unit, and is then provided to a user through an extraction member.

However, since the cold water generation unit only performs cooling and the hot water generation unit only performs heating, the heat absorbed when the purified water is cooled by the cold water generation unit is released without being utilized elsewhere. As a result, the generation of hot water relies solely on the heat output of the hot water generation unit, which leads to a delay in heating until the target hot water temperature is reached. In addition, there are limitations in generating a large amount of hot water, making it insufficient to address user complaints.

Korean Patent Registration No. 10-127195B relates to an invention concerning a water purifier using a thermoelectric element, in which a preheating module is provided on a heat dissipation side of a first thermoelectric semiconductor that cools a cold water circulation module, and water preheated by the preheating module is supplied to a hot water circulation module.

That is, in the cold water circulation module, the first thermoelectric semiconductor cools the purified water, and a preheating module is provided on the heat dissipation side where heat generated during the cooling of the purified water is dissipated, so that the purified water is heated and preheated using the heat dissipated from the first thermoelectric semiconductor, and the preheated water is supplied to the hot water circulation module. Therefore, although a structure utilizing the waste heat of the thermoelectric semiconductor as a preheating source for heating hot water is disclosed, details regarding how to control the waste heat of the thermoelectric module, how to cool the thermoelectric semiconductor, and how to circulate the hot water are not specifically described.

Korean Registered Patent No. 10-1278420B relates to an invention concerning a water purifier using a thermoelectric element, in which a cooling circulation module connected to a cooling pad of a cooling and heating module and a heating circulation module connected to a heating pad of the cooling and heating module are disclosed. The cooling and heating module absorbs heat on one side and dissipates heat on the other side, with the cooling circulation module provided on the cooling pad at the heat absorption side and the heating circulation module provided on the heating pad at the heat dissipation side, thereby enabling a single cooling and heating module to be responsible for both cold water and hot water.

That is, it discloses a structure in which a single cooling and heating module is responsible for both cooling cold water and heating hot water, and in which waste heat generated from the cooling and heating module is utilized as a heat source for heating the hot water. However, details regarding how to control the cooling and heating module and how the water heated by the cooling and heating module is circulated are not specifically described.

### DISCLOSURE

### Technical Problem

The water purifier using waste heat of a thermoelectric element according to the present invention is intended to solve the above-described problems, and the water purifier using waste heat of a thermoelectric element according to an embodiment of the present invention is directed to providing a water purifier with improved energy efficiency by utilizing waste heat generated during the cooling of purified water.

In addition, the water purifier using waste heat of a thermoelectric element according to an embodiment of the present invention is also directed to providing a water purifier capable of supplying a larger amount of hot water in a shorter time.

In addition, the water purifier using waste heat of a thermoelectric element according to an embodiment of the present invention is also directed to providing a water purifier with enhanced energy efficiency by more effectively utilizing waste heat generated during the cooling of purified water as a heat source for hot water.

The technical problems of the present invention are not limited to the technical problems mentioned above, and other technical problems not mentioned will be clearly understood by those of ordinary skill in the art from the following description.

### Technical Solution

According to an aspect of the present invention, provided is a water purifier using waste heat of a thermoelectric element, the water purifier comprising: a thermoelectric element wherein a cooling surface is formed on one side of the thermoelectric element and a heat dissipation surface is formed on the other side of the thermoelectric element; a cold water module wherein filtered purified water flows through the cold water module and the cold water module is in contact with the cooling surface of the thermoelectric element to cool the purified water; a heat dissipation module in contact with the heat dissipation surface of the thermoelectric element to release heat dissipated from the thermoelectric element to the atmosphere and to cool the heat dissipation surface; a preheating module wherein filtered purified water is temporarily stored in the preheating module and the preheating module is in contact with the heat dissipation module, which is heated by waste heat released from the heat dissipation surface of the thermoelectric element, to heat the stored purified water ; an instantaneous hot water module configured to receive the purified water heated by the preheating module and to heat the purified water preheated by the preheating module; a circulation pump configured to transfer the purified water from the preheating module to the instantaneous hot water module or to circulate the purified water from the instantaneous hot water module back to the preheating module; and a controller configured to control the circulation pump, the instantaneous hot water module, the thermoelectric element, and the heat dissipation module.

The heat dissipation module may include a heat transfer block in contact with the heat dissipation surface of the thermoelectric element;
a heat pipe in contact with at least a portion of the heat transfer block to absorb heat from the heat transfer block; and a cooling fan configured to cool the heat pipe.

The preheating module may include an inflow passage through which purified water is introduced into the preheating module; a preheating part in which a preheating space is formed to temporarily store the purified water introduced from the inflow passage, the preheating part being in contact with the heat transfer block such that heat is transferred from the heat transfer block to preheat the purified water stored in the preheating space; and an outflow passage configured to guide the purified water from the preheating part to the instantaneous hot water module.

The controller may include a temperature sensor configured to measure the temperature of purified water in the preheating module, and the controller may be configured to detect whether the thermoelectric element and the instantaneous hot water module are operating, and to control a rotation speed of the cooling fan of the heat dissipation module and an operation of the circulation pump based on the operation statuses of the thermoelectric element and the instantaneous hot water module and the temperature measured by the temperature sensor.

The controller may be configured to reduce the rotation speed of the cooling fan or stop rotation of the cooling fan when a temperature measured by the temperature sensor is lower than a target temperature set for the preheating module.

The controller may be configured to operate the circulation pump to supply the purified water preheated in the preheating module to the instantaneous hot water module when a temperature measured by the temperature sensor reaches a target temperature set for the preheating module.

The controller may be configured to rotate the cooling fan or increase the rotation speed of the cooling fan and to circulate the purified water in the preheating module using the circulation pump when cooling by the thermoelectric element is in progress in the cold water module.

The preheating part may include a preheating tank configured to form the preheating space.

The preheating part may include a preheating pipe having one end connected to the inflow passage and the other end connected to the outflow passage, the preheating pipe being bent multiple times between the inflow passage and the outflow passage, being in contact with the heat transfer block, and forming a preheating space in which the purified water is preheated.

### Advantageous Effect

According to the above configuration, the water purifier using waste heat of a thermoelectric element according to the present invention can efficiently utilize otherwise wasted energy by using waste heat generated from the thermoelectric element that cools purified water as a heat source for preheating hot water, instead of dissipating the heat directly.

In addition, the water purifier using waste heat of a thermoelectric element according to an embodiment of the present invention preheats hot water using the waste heat generated during the cooling of purified water, thereby shortening the time required to heat the water to a target temperature and reducing the waiting time for the user when dispensing hot water, which in turn can enhance user satisfaction.

In addition, the water purifier using waste heat of a thermoelectric element according to an embodiment of the present invention preheats hot water using the waste heat generated during the cooling of purified water, thereby increasing the hot water flow rate. This allows hot water to be supplied quickly even when a large amount is required by the user, thus enhancing user satisfaction.

In addition, the water purifier using waste heat of a thermoelectric element according to an embodiment of the present invention controls the operation and rotation speed of a cooling fan that cools the thermoelectric element based on the temperature of the hot water being preheated, thereby allowing the waste heat of the thermoelectric element to be more effectively concentrated on preheating the hot water, which enables more efficient use of energy.

In addition, the water purifier using waste heat of a thermoelectric element according to an embodiment of the present invention supplies the preheated hot water to the instantaneous hot water module when the temperature of the hot water being preheated reaches a preset temperature, and circulates the purified water in the preheating module so that new purified water is preheated. This increases the amount of hot water being preheated without degrading the cooling performance of the cold water module, thereby further increasing the flow rate of hot water supplied from the hot water module.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a diagram briefly illustrating the flow of internal purified water when the temperature of hot water in a preheating module is below a target temperature in a water purifier using waste heat from a thermoelectric element according to an exemplary embodiment of the present invention.

FIG. 2 is a diagram illustrating the operation status of a cooling fan and the flow of heat dissipated from a thermoelectric element when the temperature of hot water in a preheating module is below a target temperature in a water purifier using waste heat from a thermoelectric element according to an exemplary embodiment of the present invention.

FIG. 3 is a diagram briefly illustrating the flow of internal purified water when hot water in a preheating module reaches a target temperature in a water purifier using waste heat from a thermoelectric element according to an exemplary embodiment of the present invention.

FIG. 4 is a diagram briefly illustrating the flow of internal purified water when purified water is cooled in a cold water module of a water purifier using waste heat from a thermoelectric element according to an exemplary embodiment of the present invention.

FIG. 5 is a diagram illustrating the operation status of a cooling fan and the flow of heat dissipated from a thermoelectric element when purified water is cooled in a cold water module of a water purifier using waste heat from a thermoelectric element according to an exemplary embodiment of the present invention.

FIG. 6 is a view illustrating an example of a preheating module of a water purifier using waste heat from a thermoelectric element according to an exemplary embodiment of the present invention.

FIG. 7 is a view illustrating another example of a preheating module of a water purifier using waste heat from a thermoelectric element according to an exemplary embodiment of the present invention.

### BEST MODES FOR CARRYING OUT THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

Hereinafter, a water purifier 100 using waste heat from a thermoelectric element 120 according to an embodiment of the present invention will be described with reference to the drawings.

A water purifier 100 using waste heat from a thermoelectric element 120 according to an embodiment of the present invention may include a thermoelectric element 120, a cold water module 130, a heat dissipation module 140, a preheating module 150, an instantaneous hot water module 160, a circulation pump 170, and a controller 180.

The thermoelectric element 120 is an element that generates a temperature difference by being supplied with electric power, and may be, for example, a Peltier element.

When electric power is supplied to the thermoelectric element 120, a cooling surface 122 that is cooled may be formed on one side surface, and a heat dissipation surface 124 that generates heat may be formed on the other side surface.

That is, heat is absorbed on one side surface and the absorbed heat is dissipated on the other side surface.

The cold water module 130 is configured to receive purified water filtered by the filter 110, and is provided to contact the cooling surface 122 of the thermoelectric element 120 so as to cool the purified water to produce cold water.

That is, the cold water module 130 cools the purified water by contacting one side surface, which is the cooling surface 122 of the thermoelectric element 120. The thermoelectric element 120 may absorb heat from the purified water through the cooling surface 122 to cool the purified water, and then dissipate the absorbed heat through the heat dissipation surface 124.

The heat dissipation module 140 may contact the heat dissipation surface 124 and dissipate heat emitted from the thermoelectric element 120 into the atmosphere to cool the thermoelectric element 120.

Here, the heat dissipated from the thermoelectric element 120 will be referred to as waste heat.

The preheating module 150 may be configured to temporarily store purified water filtered by the filter 110, and to heat the stored purified water by contacting the heat dissipation module 140, which is heated by waste heat emitted from the heat dissipation surface of the thermoelectric element 120.

The instantaneous hot water module 160 may be configured to receive purified water heated by the preheating module 150 and to heat the purified water preheated by the preheating module 150.

The circulation pump 170 may be configured to transfer the purified water heated by the preheating module 150 to the instantaneous hot water module 160 or to circulate the purified water of the instantaneous hot water module 160 back to the preheating module 150.

The water purifier may further include a flow path 102 configured to guide raw water to the filter 110, a flow path 104 configured to guide purified water filtered by the filter 110 to the cold water module 130, a flow path 106 configured to guide purified water filtered by the filter 110 to the instantaneous hot water module 160, and a flow path 108 configured to circulate the purified water of the instantaneous hot water module 160 to the preheating module 150 or to circulate the purified water of the preheating module 150 to the instantaneous hot water module 160.

The water purifier may further include a flow path 192 configured to guide the purified water of the cold water module 130 to a cold water extraction cock and a flow path 194 configured to guide the purified water of the instantaneous hot water module 160 to a hot water extraction cock.

The controller 180 may control the circulation pump 170, the instantaneous hot water module 160, the thermoelectric element 120, and the heat dissipation module 140 according to the operation of the cold water module 130 and the temperature of the purified water in the preheating module 150 to control the amount of heat transferred from the heat dissipation module 140 to the preheating module 150 as needed.

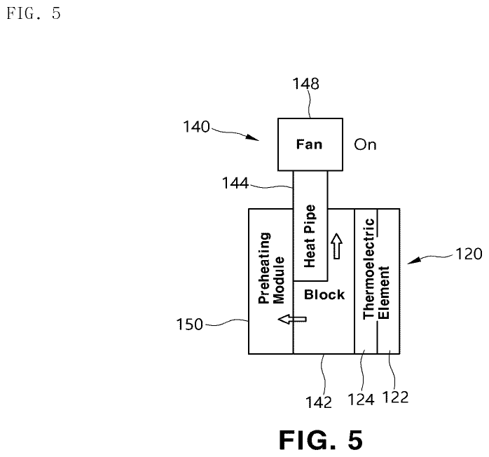

The heat dissipation module 140 may include a heat transfer block 142, a heat pipe, and a cooling fan 148, as illustrated in FIG. 5.

The heat transfer block 142 may be provided to contact the heat dissipation surface 124 of the thermoelectric element 120 and may be formed of a copper or aluminum alloy having excellent thermal conductivity.

The heat transfer block 142 may have one surface provided on the heat dissipation surface of the thermoelectric element 120 and the other surface in contact with a preheating part 154 of the preheating module 150.

The heat pipe may be provided in contact with the heat transfer block 142 to absorb heat from the heat transfer block 142. The heat pipe 144 may also be directly in contact with the preheating module 150 in some sections, as needed.

The heat pipe is a component configured to transfer heat by self-circulating through a phase change of the absorbed heat, and the heat pipe may extend upward from the heat transfer block 142, with a cooling fan 148 provided at the extended upper portion.

The cooling fan 148 may be configured to be controlled in terms of rotation and rotation speed by the controller 180, and may be provided to cool the heat pipe.

In addition, a heat dissipation fin 146 may be installed at a point where the cooling fan 148 is mounted on the heat pipe to maximize the heat dissipation area, thereby allowing the heat pipe to be cooled more efficiently.

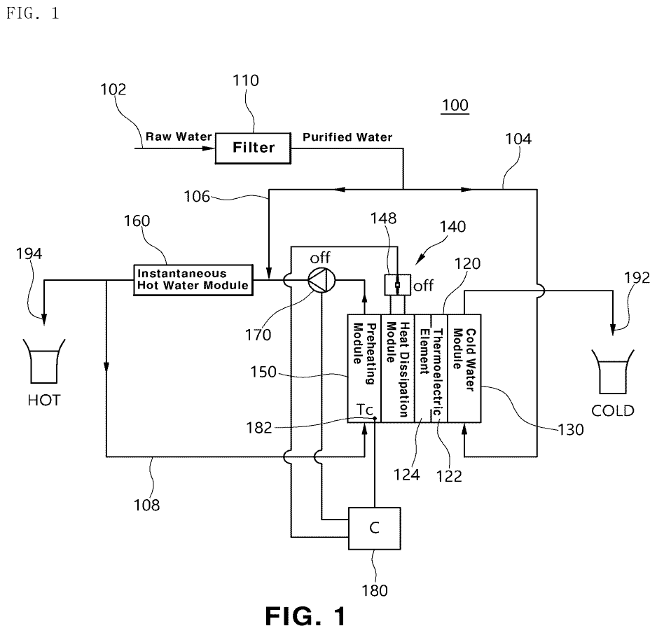

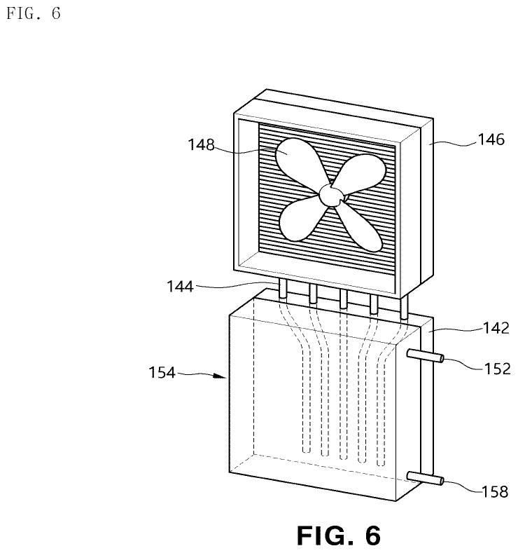

The preheating module 150 may include an inflow passage 152, a preheating part 154, and an outflow passage 158, as illustrated in FIGS. 1 and 6. The inflow passage 152 may form a passage through which purified water flows in, and the preheating part 154 may form a preheating space in which the purified water introduced from the inflow passage 152 is temporarily stored. The preheating part 154 may be provided to contact the heat transfer block 142 or the heat pipe so that heat is transferred from the heat transfer block 142 to preheat the purified water stored in the preheating space. In addition, the outflow passage 158 may guide the purified water of the preheating part 154 to the instantaneous hot water module 160.

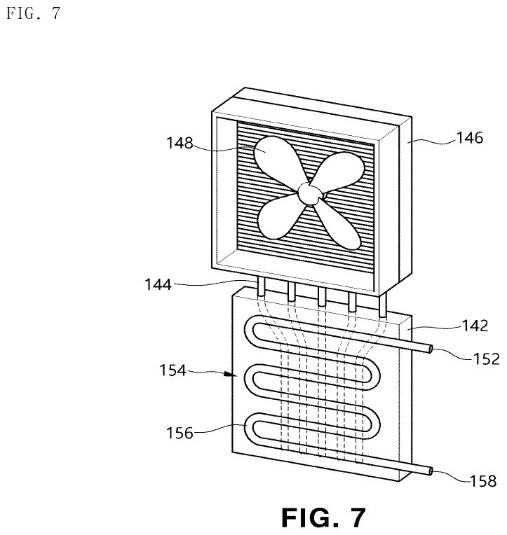

As illustrated in FIG. 6, the preheating part 154 may be formed as a preheating tank 155 in which the introduced purified water is stored, having a larger cross-sectional area than the inflow passage 152 and the outflow passage 158 so that the introduced purified water can remain therein. Alternatively, as illustrated in FIG. 7, the preheating part 154 may be continuously formed with the inflow passage 152 and the outflow passage 158, and may be a preheating pipe 156 that is bent multiple times within a region contacting the heat transfer block 142 or the heat pipe 144 to increase a contact area with the heat pipe 144 or the heat transfer block 142.

Therefore, the purified water may be supplied to the preheating part 154 through the inflow passage 152, preheated in the preheating part 154 by the waste heat of the thermoelectric element 120, and discharged toward the instantaneous hot water module 160 through the outflow passage 158.

Meanwhile, the controller 180 may include a temperature sensor 182 configured to measure the temperature of the purified water in the preheating module 150, and may be configured to detect the operation status of the thermoelectric element 120 and the instantaneous hot water module 160 and to control the operation of the cooling fan 148 and the circulation pump 170.

Therefore, the controller 180 may control the rotation speed of the cooling fan 148 of the heat dissipation module 140 and the operation of the circulation pump 170 based on the operation status of the thermoelectric element 120 and the instantaneous hot water module 160 and the temperature measured by the temperature sensor 182, thereby adjusting the amount of heat transferred from the heat dissipation module 140 to the preheating module 150.

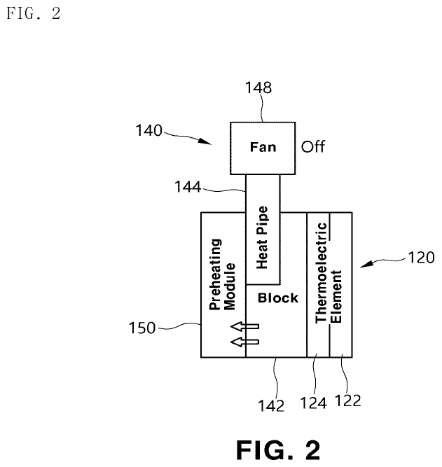

Meanwhile, a target preheating temperature of the preheating module 150 may be set in the controller 180. As illustrated in FIGS. 1 and 2, when the temperature of the purified water in the preheating module 150 measured by the temperature sensor 182 is lower than the set target temperature, the controller 180 may reduce the rotation speed of the cooling fan 148 or stop the rotation of the cooling fan 148 so that the amount of heat dissipated into the atmosphere from the heat dissipation surface of the thermoelectric element 120 is decreased and the amount of heat transferred to the preheating module 150 is increased.

Therefore, when the cooling fan 148 is stopped or the rotation speed of the cooling fan 148 is reduced, the amount of heat dissipated into the atmosphere by the cooling fan 148 from the heat dissipated by the thermoelectric element 120 is reduced, and the amount of heat transferred to the preheating module 150 is increased, thereby enabling the purified water in the preheating module 150 to be quickly heated to the target temperature.

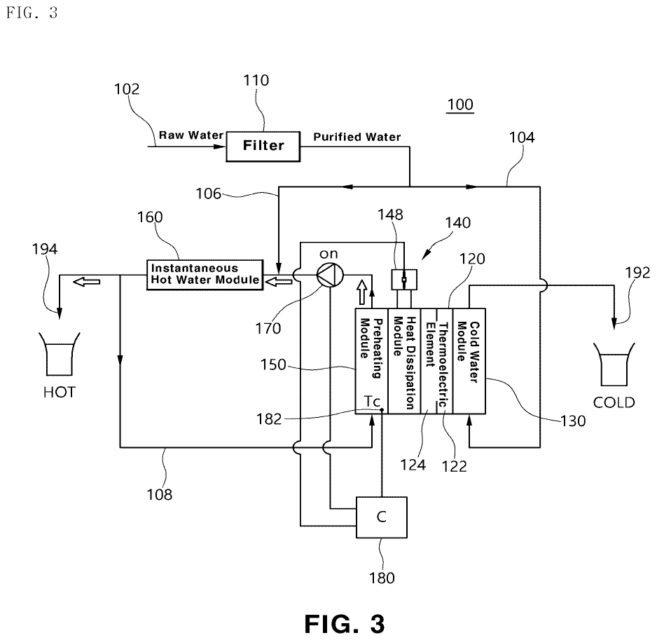

In addition, as illustrated in FIG. 3, when the temperature of the purified water in the preheating module 150 measured by the temperature sensor 182 reaches the set target temperature, the controller 180 may operate the circulation pump 170 to control the supply of the purified water, preheated to the target temperature in the preheating module 150, to the instantaneous hot water module 160.

Therefore, since the preheated purified water is supplied to the instantaneous hot water module 160, the instantaneous hot water module 160 can heat the water to the set temperature in a shorter time, and as a result, a larger amount of hot water can be provided in the same amount of time, thereby allowing a greater amount of hot water to be supplied to the user more quickly.

In addition, as the water preheated in the preheating module 150 is supplied to the instantaneous hot water module 160, unheated purified water may simultaneously flow into the preheating module 150 and be preheated again. The unheated purified water may absorb waste heat from the heat dissipation surface of the thermoelectric element 120 to cool the thermoelectric element 120.

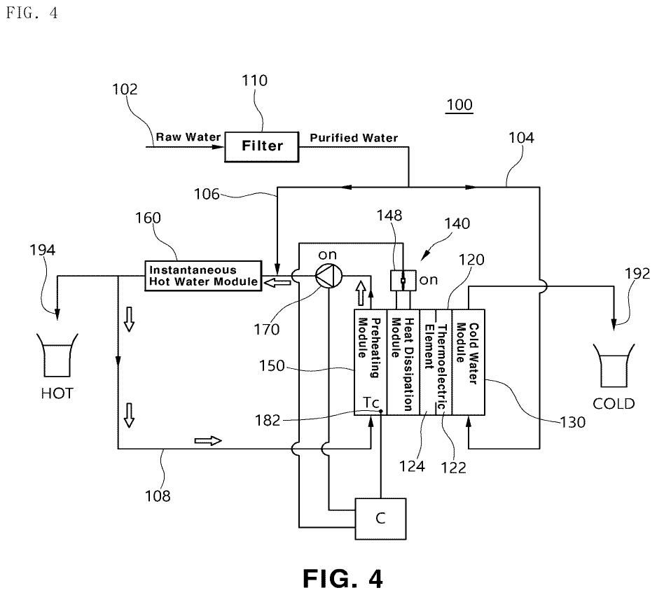

Meanwhile, as illustrated in FIGS. 4 and 5, when cooling by the thermoelectric element 120 is in progress in the cold water module 130, the controller 180 may operate the cooling fan 148 to rotate or increase the rotation speed of the cooling fan 148 and operate the circulation pump 170 to circulate the purified water in the preheating module 150, so that the heat dissipation surface of the thermoelectric element 120 is cooled by both the cooling by the heat dissipation module 140 and the purified water in the preheating module 150.

That is, by operating the cooling fan 148 or increasing the rotation speed of the cooling fan 148, heat dissipated from the heat dissipation surface of the thermoelectric element 120 may be dissipated into the atmosphere by the heat dissipation module 140, and also, by operating the circulation pump 170, the purified water in the preheating module 150 may be circulated so that unheated purified water flows into the preheating module 150 and absorbs waste heat from the heat dissipation surface of the thermoelectric element 120 to cool the thermoelectric element 120.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the idea scope of the present invention.

1. A water purifier using waste heat of a thermoelectric element, the water purifier comprising:
a thermoelectric element wherein a cooling surface is formed on one side of the thermoelectric element and a heat dissipation surface is formed on the other side of the thermoelectric element;
a cold water module wherein filtered purified water flows through the cold water module and the cold water module is in contact with the cooling surface of the thermoelectric element to cool the purified water;
a heat dissipation module in contact with the heat dissipation surface of the thermoelectric element to release heat dissipated from the thermoelectric element to the atmosphere and to cool the heat dissipation surface;
a preheating module wherein filtered purified water is temporarily stored in the preheating module and the preheating module is in contact with the heat dissipation module, which is heated by waste heat released from the heat dissipation surface of the thermoelectric element, to heat the stored purified water;
an instantaneous hot water module configured to receive the purified water heated by the preheating module and to heat the purified water preheated by the
a circulation pump configured to transfer the purified water from the preheating module to the instantaneous hot water module or to circulate the purified water from the instantaneous hot water module back to the preheating module; and
a controller configured to control the circulation pump, the instantaneous hot water module, the thermoelectric element, and the heat dissipation module according to an operation of the cold water module and a temperature of the purified water in the preheating module, and to control, as necessary, an amount of heat transferred from the heat dissipation module to the preheating module.

2. The water purifier using waste heat of a thermoelectric element according to claim 1, wherein the heat dissipation module comprises:
a heat transfer block in contact with the heat dissipation surface of the thermoelectric element;
a heat pipe in contact with at least a portion of the heat transfer block to absorb heat from the heat transfer block; and
a cooling fan configured to cool the heat pipe.

3. The water purifier using waste heat of a thermoelectric element according to claim 2, wherein the preheating module comprises:
an inflow passage through which purified water is introduced into the preheating module;
a preheating part in which a preheating space is formed to temporarily store the purified water introduced from the inflow passage, the preheating part being in contact with the heat transfer block such that heat is transferred from the heat transfer block to preheat the purified water stored in the preheating space; and
an outflow passage configured to guide the purified water from the preheating part to the instantaneous hot water module.

4. The water purifier using waste heat of a thermoelectric element according to claim 2, wherein the controller comprises:
a temperature sensor configured to measure the temperature of purified water in the preheating module,
wherein the controller is configured to detect whether the thermoelectric element and the instantaneous hot water module are operating, and to control a rotation speed of the cooling fan of the heat dissipation module and an operation of the circulation pump based on the operation statuses of the thermoelectric element and the instantaneous hot water module and the temperature measured by the temperature sensor.

5. The water purifier using waste heat of a thermoelectric element according to claim 4, wherein the controller is configured to reduce the rotation speed of the cooling fan or stop rotation of the cooling fan so that, when a temperature measured by the temperature sensor is lower than a target temperature set for the preheating module, an amount of heat dissipated to the atmosphere from the heat dissipation surface of the thermoelectric element is reduced and heat dissipated from the thermoelectric element is directed toward the preheating module.

6. The water purifier using waste heat of a thermoelectric element according to claim 4, wherein the controller is configured to operate the circulation pump to supply the purified water preheated in the preheating module to the instantaneous hot water module when a temperature measured by the temperature sensor reaches a target temperature set for the preheating module.

7. The water purifier using waste heat of a thermoelectric element according to claim 4, wherein the controller is configured to rotate the cooling fan or increase the rotation speed of the cooling fan and to circulate the purified water in the preheating module using the circulation pump so that, when cooling by the thermoelectric element is in progress in the cold water module, the heat dissipation surface of the thermoelectric element is cooled both by the heat dissipation module and by the purified water in the preheating module.

8. The water purifier using waste heat of a thermoelectric element according to claim 3, wherein the preheating part comprises a preheating tank configured to form the preheating space.

9. The water purifier using waste heat of a thermoelectric element according to claim 3, wherein the preheating part comprises a preheating pipe having one end connected to the inflow passage and the other end connected to the outflow passage, the preheating pipe being bent multiple times between the inflow passage and the outflow passage, being in contact with the heat transfer block, and forming a preheating space in which the purified water is preheated.
